(19) United States
(12) Patent Application Publication
(10) Pub. No.: US 2013/0095350 A1
(43) Pub. Date: Apr. 18, 2013

(54) BATTERY PACK AND POWER TOOL

(71) Applicants: Takao Aradachi, Ibaraki (JP); Hiroyuki Hanawa, Ibaraki, (JP)

(72) Inventors: Takao Aradachi, Ibaraki (JP); Hiroyuki Hanawa, Ibaraki, (JP)

(73) Assignee: HITACHI KOKI CO., LTD., Tokyo (JP)

(21) Appl. No.: 13/703,021

(22) PCT Filed: Jun. 29, 2011
(86) PCT No.: PCT/JP2011/065420

§ 371 Date: Dec. 9, 2012

(30) Foreign Application Priority Data
Jun. 30, 2010 (JP) 2010-148699

(51) Int. Cl. H01M 10/42

(52) U.S. Cl. CPC H01M 10/425
USPC 429/7

(57) ABSTRACT

A battery pack, includes: a battery set including at least one battery cell; a protection IC configured to protect plural kinds of the battery sets, which produce different voltages, from overcharging and overdischarging, the protection IC including terminals for setting the different voltages of the battery sets; and a board configured to mount, on a surface of the board, circuit components including the protection IC and a connection unit which is connected to the terminals based on the produced voltage of the battery set to be connected to the protection IC.

### TECHNICAL FIELD

The present invention relates to a battery pack such as a lithium ion battery serving as the power source of a cordless power tool and the power tool using it.

### BACKGROUND ART

In the power tools, the batteries serving as the power sources of cordless power tools have been demanded to have more capacities and to be further downsized. According to such the demands, lithium ion batteries each having high output density have been employed recently.

When the lithium ion battery is overcharged, overdischarged or overloaded, the battery may be degraded or become failure. Thus, in general, a safety measure is provided in the following manner. That is, a dedicated protection IC or microcomputer is provided in a battery pack so as to monitor the occurrence of overcharge, overdischarge or overload. When a battery voltage is equal to or more than or less than a predetermined value or when a current of a predetermined value or more flows, the dedicated protection IC or microcomputer outputs a signal to interrupt a charging/discharging path based on the signal (see JP-A-6-141479).

### SUMMARY

As described above, in general, the battery pack of the lithium ion battery is provided with a protection circuit for preventing the occurrence of overcharge, overdischarge or overload. The general protection method against the overcharging is to monitor the voltage of each cell of the lithium ion battery so as not to exceed 4.25 V/cell. On the other hand, in the case of charging the lithium ion battery under the constant current/constant voltage control which is the general method of charging the lithium ion battery, it is necessary to control the voltage with a high accuracy near 4.20 V/cell which is quite close to the aforesaid 4.25 V/cell. Thus, it is necessary to detect the voltage with a quite high accuracy in the case of monitoring the voltage of 4.25 V/cell determined to be the overcharging.

Thus, a protection IC dedicated to the lithium ion battery, which can detect with a high accuracy that the cell voltage reaches a predetermined voltage, is put on the market as a protection circuit for the lithium ion battery. When such the protection IC is employed, the voltage can be monitored easily with a high accuracy without providing a complicated circuit etc. However, in such the protection IC, since the number of cells to be monitored is fixed to some extent, there are various problems in order to monitor the voltage of the battery pack configured by many cells. At present, in the protection IC of a stand-alone type, the maximum number of cells to be monitored is four as the main. Thus, it is sufficient to use the single IC for four cells in order to monitor the battery of four cells. However, in the case of monitoring the battery of five cells, for example, the protection is performed according to such a method of employing the IC for four cells and the IC for a single cell, that is, two ICs in total. According to such the method, it is necessary to separately prepare protection boards for the battery pack for four cells and the battery pack for five cells, respectively, since the circuit configuration basically differs between these boards. Thus, it is disadvantageous in the points of development cost and manufacturing management.

Accordingly, an object of an aspect of the disclosure is to provide a battery pack and a power tool using it, which can eliminate the aforesaid drawback of the related art and can reduce the development cost by providing a common protection board for protecting battery cells in battery packs such as lithium ion batteries of different voltages.

The aspect of the disclosure provides the following arrangements:
(1) A battery pack, comprising:

a battery set including at least one battery cell;

a protection IC configured to protect plural kinds of the battery sets, which produce different voltages, from overcharging and overdischarging, the protection IC including terminals for setting the different voltages of the battery sets; and

a board configured to mount, on a surface of the board, circuit components including the protection IC and a connection unit which is connected to the terminals based on the produced voltage of the battery set to be connected to the protection IC.
(2) The battery pack according to (1), wherein

the connection unit includes jumper resistors which connect between the terminals of the protection IC and one of the batteries or a ground level on the board.
(3) The battery pack according to (2), further comprising:

an insertion portion configured to attach the battery pack to a power tool,

wherein the insertion portion has a space where the board is disposed and where the battery cells are not disposed, and

wherein a shape of the insertion portion and a shape of the space are same in each of the battery sets which produce different voltages.
(4) The battery pack according to (3), wherein

the protection IC has a function of monitoring voltages of the respective cells of the battery set, and

detection lines for monitoring the voltages of the cells are respectively connected between the cells and the board.
(5) The battery pack according to (2), wherein

the protection IC has a function of monitoring voltages of the respective cells of the battery set,

detection terminals for monitoring the voltages of the cells are respectively set to the cells, and

the detection terminals are connected within the board.
(6) The battery pack according to (1), wherein the connection unit is connected to the terminals in one of a plurality of circuit configurations based on the produced voltage of the battery set to be connected to the protection IC.
(7) The battery pack according to one of (1) to (6), wherein the battery cell is a lithium ion battery.
(8) A battery pack, comprising:

a battery set including at least one battery cell;

a protection IC configured to protect the battery cell from overcharging and overdischarging; and

a board which mounts circuit components including the protection IC thereon,

wherein a plurality of circuit patterns to be connected to the protection IC are formed on the board, and

wherein the protection IC is connected to at least one of the plurality of circuit patterns according to a number of the battery cells of the battery set to be protected.

0 9. A power tool using the battery pack according to one of claims 1 to 8.

According to the above aspect of the disclosure, it becomes possible to provide a battery pack and a power tool using it, which can reduce the development cost by providing a common protection board for protecting battery cells in battery packs such as lithium ion batteries of different voltages.

### BRIEF DESCRIPTION OF THE DRAWINGS

FIG. 1 is a diagram showing an example of a protection board for protecting a battery of five cells in a battery pack according to an exemplary embodiment of the invention.

FIG. 2 is a diagram showing an example of the protection board for protecting a battery of four cells in the battery pack according to the exemplary embodiment of the invention.

FIG. 3 is a diagram showing an example of the protection board for protecting a battery of three cells in the battery pack according to the exemplary embodiment of the invention.

FIG. 4 is a diagram showing an example of the protection board for protecting a battery of two cells in the battery pack according to the exemplary embodiment of the invention.

FIG. 5 is a diagram showing a list of the terminal connections of protection ICs coping with five to two cells in the battery packs according to the exemplary embodiment of the invention.

FIG. 6 is a diagram showing an example of the exterior view of a power tool driven by an insertion type battery pack according to the exemplary embodiment of the invention.

FIGS. 7A and 7B are diagrams showing examples (FIG. 7A: five cells, FIG. 7B: four cells) of the configurations of the insertion type battery pack for driving the power tool shown in FIG. 6.

FIG. 8A is a diagram showing an example of the exterior view of the power tool driven by a slide type battery pack and FIG. 8B is a diagram showing an example of the exterior view of the battery pack.

FIGS. 9A and 9B are diagrams showing examples (FIG. 9A: five cells, FIG. 9B: four cells) of the configurations of a slide type battery pack for driving the power tool shown in FIG. 8.

### DESCRIPTION OF EXEMPLARY EMBODIMENTS

The exemplary embodiment will be explained in detail based on accompanying drawings. In the entire drawings for explaining the exemplary embodiment, same portions are principally referred to by the common symbols, with repetitive explanation thereof being omitted.

### Battery Pack Having Protection Board for Protecting Battery of Five Cells

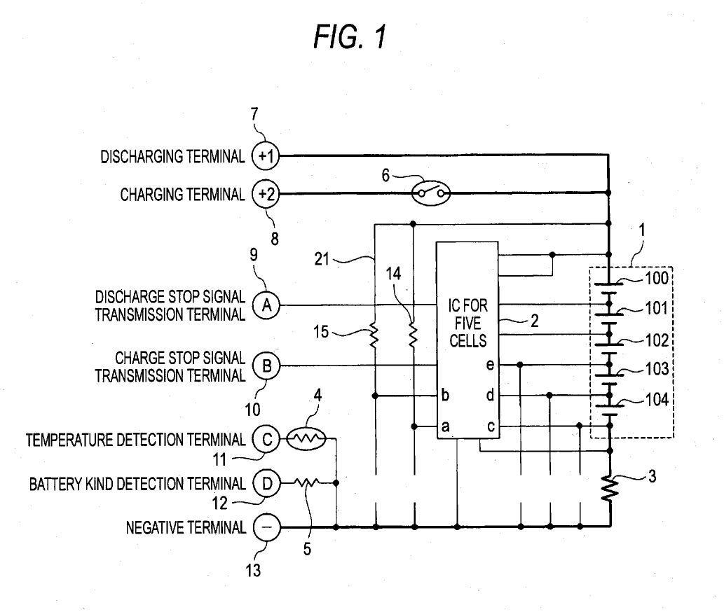

First, the explanation will be made with reference to FIG. 1 as to a battery pack (a battery pack having a protection board for protecting the battery of five cells) according to the exemplary embodiment. FIG. 1 is a diagram showing an example of the protection board for protecting the battery of five cells in the battery pack according to the exemplary embodiment.

The battery pack according to the exemplary embodiment includes a battery cell set 1, a protection IC 2, a shunt resistor 3, a thermo-sensitive element 4, an identification resistor 5, a thermal protector 6, terminals 7 to 13 for connecting the battery pack, jumper resistors 14, 15 etc. In this battery pack configuration, the circuit components of the protection IC 2, the shunt resistor 3, the thermo-sensitive element 4, the identification resistor 5, the thermal protector 6 and the jumper resistors 14, 15 are mounted on the protection board.

The battery cell set 1 is configured by five battery blocks 100, 101, 102, 103 and 104 of the lithium ion battery which are connected in series in the order of higher voltage in this order. Although each of the battery blocks 100 to 104 is configured by a single cell or at least two cells connected in parallel, the explanation will be made in this case that the number of the cells is same as the number of the battery blocks.

The protection IC 2 is a protection IC for the lithium ion battery of five cells. The protection IC acts to monitor the voltages of the five battery blocks 100 to 104 and detects the voltage drop caused at the shunt resistor 3 provided between the negative terminal of the battery block 104 and a load to thereby detect overload. The protection IC is also configured to determine overvoltage when the voltage of at least one of the five battery blocks 100 to 104 being monitored becomes a predetermined voltage or more and output a predetermined signal. On the contrary, the protection IC is configured to determine overdischarge when the voltage of at least one of the five battery blocks 100 to 104 being monitored becomes a predetermined voltage or less and output a predetermined signal. The protection IC is also configured to output a predetermined signal when the protection IC detects the aforesaid overload.

The protection IC 2 for the lithium ion battery of five cells is provided with terminals for setting the voltage of the lithium ion battery, that is, terminals a, b, c, d, e for setting the number of the cells for determining this voltage. When the IC is set so as to protect the battery of five cells, the terminals a, b are connected to a high voltage side of the battery, the terminal c is connected to the negative voltage side of the battery (the battery block 104 in this case) having the lowest voltage among the five cells, the terminal d is connected to the negative voltage side of the battery (the battery block 103 in this case) having the second-lowest voltage, and the terminal e is connected to the negative voltage side of the battery (the battery block 102 in this case) having the third-lowest voltage.

The shunt resistor 3 is a resistor for detecting the overload provided between the battery block 104 and the load as described above.

The thermo-sensitive element 4 is an element such as a thermistor for monitoring the temperature of the battery provided near the battery cell set 1.

The identification resistor 5 is a resistor for identifying the kinds of the batteries (It is necessary to identify between the battery of four cells and the battery of five cells in the case of supposing batteries coping with a battery charger capable of charging both the battery of four cells and the battery of five cells, for example. This is also applied to the case of identifying the battery of two cells and the battery of three cells). The identification resistor is set to have a peculiar resistance value for each of the battery packs having different voltages.

The thermal protector 6 is a protector provided near the battery cell set 1 in order to protect the battery from overcurrent and abnormal high-temperature etc. at the time of the charging. For example, when the overcurrent flows into the battery due to any kind of failure of the battery charger, the temperature of the thermal protector 6 provided near the battery becomes high according to the increase of the temperature of the battery. When the temperature of the thermal protector 6 reaches a predetermined value, the thermal protector is placed in an opened state to interrupt the current path to thereby protect the battery.

The discharging terminal 7 of the positive polarity is a discharging terminal for connecting the positive terminal of the battery cell set 1 (the positive terminal of the battery block 100) and a load such as the motor of the power tool.

The charging terminal 8 of the positive polarity is a charging terminal for connecting the positive terminal of the battery cell set 1 (the positive terminal of the battery block 100) and the positive terminal of the battery charger. The discharging terminal 7 and the charging terminal 8 may be unified to form a single positive terminal.

The discharge stop signal transmission terminal 9 is a terminal for a discharge stop signal for transmitting the signal for stopping the discharging to the power tool side from the protection IC 2 at the time of the overdischarging or the overload. The power tool is configured to interrupt the discharging path in response to the reception of the discharge stop signal (for example, a switching element such as an FET is provided in the current path and the FET etc. is turned off in response to the reception of the discharge stop signal).

The charge stop signal transmission terminal 10 is a terminal for a charge stop signal for transmitting the signal for stopping the charging to the battery charger side from the protection IC 2 at the time of the overcharging. The battery charger is configured to interrupt the charging path in response to the reception of the charge stop signal (for example, a switching element such as a relay is provided in the current path and the relay etc. is turned off in response to the reception of the charge stop signal).

The temperature detection terminal 11 is a terminal for temperature detection for transmitting temperature information based on the output of the thermo-sensitive element 4 such as the thermistor to the battery charger. For example, the battery charger side is configured to stop the charging when the battery temperature detected via the temperature detection terminal 11 reaches a predetermined value or more.

The battery kind detection terminal 12 is a terminal for detecting the kind of the battery for transmitting battery kind information (for example, the number of the cells) based on the identification resistor 5 to the battery charger side. The battery charger side is configured to set the charging method according to the battery kind information detected via the battery kind detection terminal 12.

The negative terminal 13 is a terminal to be connected to the power tool and the negative terminal of the battery charger.

The jumper resistors 14, 15 are a connecting unit for connecting the terminals a, b among the terminals a, b, c, d, e of the protection IC 2 to the battery voltages in correspondence to the number of the cells which determines the voltage of the battery.

In the protection board for protecting the battery of five cells shown in FIG. 1, the protection IC 2 for the lithium ion battery of five cells is mounted on the board. The terminal a of the protection IC 2 is connected to the battery voltage (the positive voltage side of the battery block 100) via the jumper resistor 14, the terminal b is connected to the battery voltage (the positive voltage side of the battery block 100) via the jumper resistor 15, the terminal c is connected to the negative voltage side of the battery block 104 having the lowest voltage among the five cells, the terminal d is connected to the negative voltage side of the battery block 103 having the second-lowest voltage, and the terminal e is connected to the negative voltage side of the battery block 102 having the third-lowest voltage.

### Battery Pack Having Protection Board for Protecting Battery of Four Cells

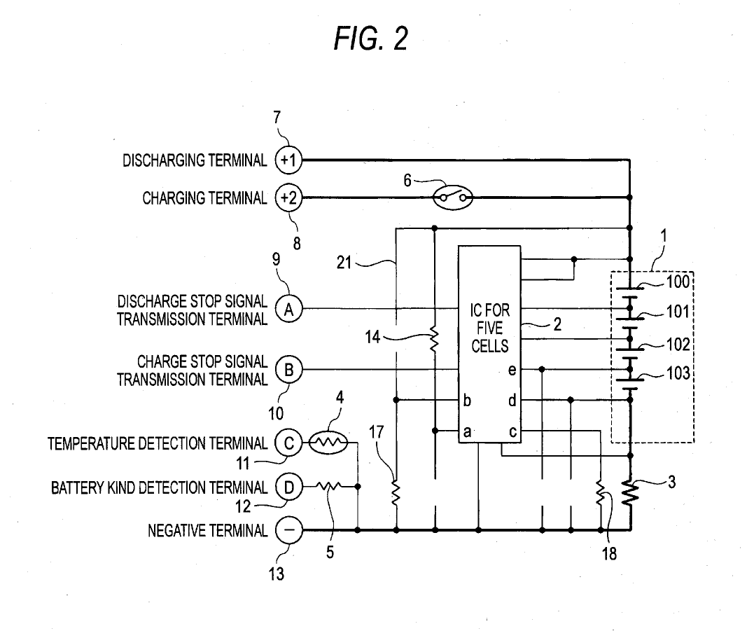

Next, the explanation will be made with reference to FIG. 2 as to a battery pack having a protection board for protecting the battery of four cells. FIG. 2 is a diagram showing an example of the protection board for protecting the battery of four cells in the battery pack according to the exemplary embodiment.

In the battery pack shown in FIG. 2, the battery cell set 1 is configured by four battery blocks 100, 101, 102, and 103 of the lithium ion battery which are connected in series in the order of higher voltage in this order.

In the protection board for protecting the battery of the four cells shown in FIG. 2, the basic functions of the terminals thereof are same as those of the protection board for protecting the battery of the five cells shown in FIG. 1. However, although the protection IC 2 same as the protection IC for the lithium ion battery of five cells shown in the example of FIG. 1 is also used in this case, the setting of the terminal b and the terminal c of this protection IC 2 differs from that of the example shown in FIG. 1.

That is, in the case of the setting of the five cells, the terminal b is connected to the battery voltage via the jumper resistor 15. However, in the case of the setting of the four cells, the terminal b is connected to the ground level via the jumper resistor 17. Further, in the case of the setting of the five cells, the terminal c is connected to the battery having the lowest voltage among the five cells (negative voltage side of the battery block 104). However, in the case of the setting of the four cells, the terminal c is connected to the ground level via the jumper resistor 18.

In the protection board for protecting the battery of four cells shown in FIG. 2, the protection IC 2 for the lithium ion battery of five cells is mounted on the board. The terminal a of the protection IC 2 is connected via the jumper resistor 14 to the positive voltage side of the battery block 100 as the battery voltage, the terminal b is connected to the ground level via the jumper resistor 17, the terminal c is connected to the ground level via the jumper resistor 18, the terminal d is connected to the negative voltage side of the battery block 103, and the terminal e is connected to the negative voltage side of the battery block 102.

### Battery Pack Having Protection Board for Protecting Battery of Three Cells

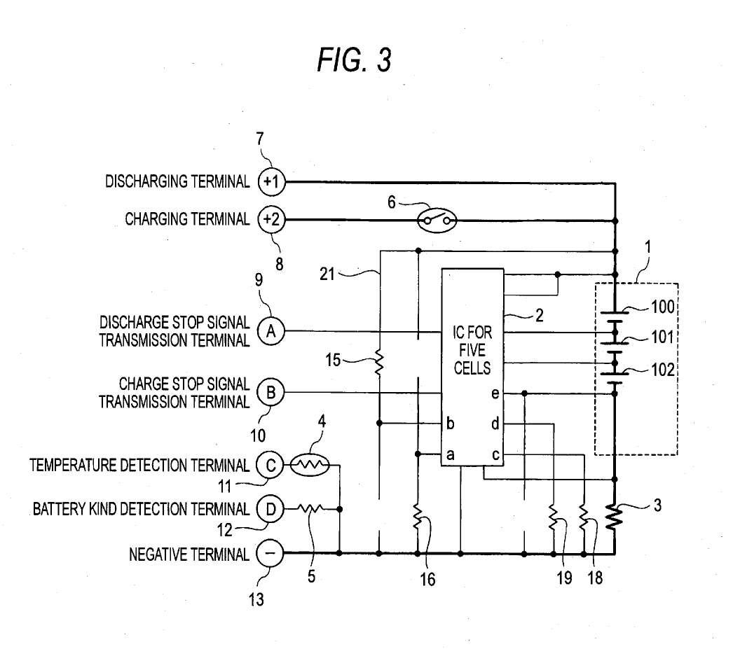

Next, the explanation will be made with reference to FIG. 3 as to a battery pack having a protection board for protecting the battery of three cells. FIG. 3 is a diagram showing an example of the protection board for protecting the battery of thee cells in the battery pack according to the exemplary embodiment.

In the battery pack shown in FIG. 3, the battery cell set 1 is configured by three battery blocks 100, 101, and 102 of the lithium ion battery which are connected in series in the order of higher voltage in this order.

In the protection board for protecting the battery of the three cells shown in FIG. 3, the basic functions of the terminals thereof are same as those of the protection board for protecting the battery of the five cells shown in FIG. 1. However, although the protection IC 2 same as the protection IC for the lithium ion battery of five cells shown in the example of FIG. 1 is also used in this case, the setting of the terminal a, the terminal c and the terminal d of this protection IC 2 differs from that of the example shown in FIG. 1.

That is, in the case of the setting of the five cells, the terminal a is connected to the battery voltage via the jumper resistor 14. However, in the case of the setting of the three cells, the terminal a is connected to the ground level via the jumper resistor 16. Further, in the case of the setting of the five cells, the terminal c is connected to the battery having the lowest voltage among the five cells (negative voltage side of the battery block 104). However, in the case of the setting of the three cells, the terminal c is connected to the ground level via the jumper resistor 18. Further, in the case of the setting of the five cells, the terminal d is connected to the battery having the second-lowest voltage among the five cells (negative voltage side of the battery block 103). However, in the case of the setting of the three cells, the terminal d is connected to the ground level via the jumper resistor 19.

In the protection board for protecting the battery of three cells shown in FIG. 3, the protection IC 2 for the lithium ion battery of five cells is mounted on the board. The terminal a of the protection IC 2 is connected to the ground level via the jumper resistor 16, the terminal b is connected via the jumper resistor 15 to the positive voltage side of the battery block 100 as the battery voltage, the terminal c is connected to the ground level via the jumper resistor 18, the terminal d is connected to the ground level via the jumper resistor 19 and the terminal e is connected to the negative voltage side of the battery block 102.

### Battery Pack Having Protection Board for Protecting Battery of Two Cells

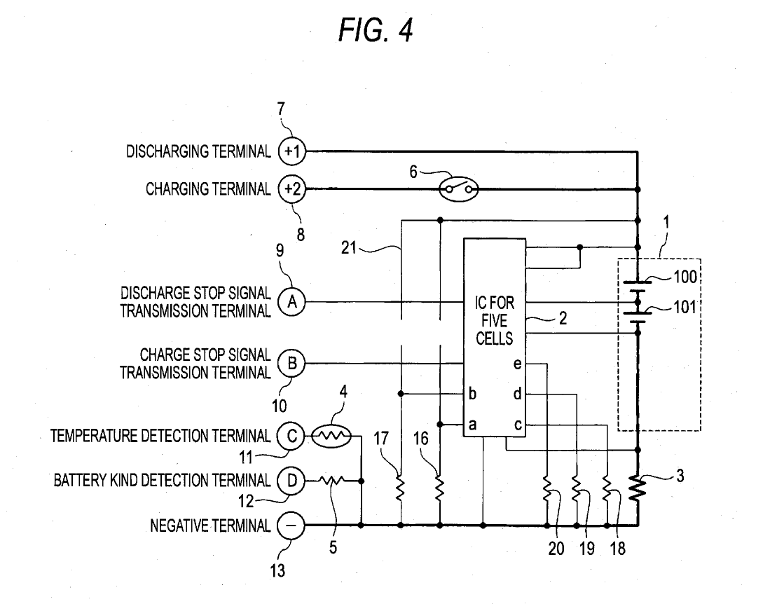

Next, the explanation will be made with reference to FIG. 4 as to a battery pack having a protection board for protecting the battery of two cells. FIG. 4 is a diagram showing an example of the protection board for protecting the battery of two cells in the battery pack according to the exemplary embodiment.

In the battery pack shown in FIG. 4, the battery cell set 1 is configured by two battery blocks 100 and 101 of the lithium ion battery which are connected in series in the order of higher voltage in this order.

In the protection board for protecting the battery of the two cells shown in FIG. 4, the basic functions of the terminals thereof are same as those of the protection board for protecting the battery of the five cells shown in FIG. 1. However, although the protection IC 2 same as the protection IC for the lithium ion battery of five cells shown in the example of FIG. 1 is also used in this case, the setting of the terminal a, the terminal b, the terminal c, the terminal d and the terminal e of this protection IC 2 differs from that of the example shown in FIG. 1.

That is, while the terminal a is connected to the battery voltage via the jumper resistor 14 in the case of the setting of the five cells, the terminal a is connected to the ground level via the jumper resistor 16 in the case of the setting of the two cells. While the terminal b is connected to the battery voltage via the jumper resistor 15 in the case of the setting of the five cells, the terminal b is connected to the ground level via the jumper resistor 17 in the case of the setting of the two cells. Further, while the terminal c is connected to the battery having the lowest voltage among the five cells (negative voltage side of the battery block 104) in the case of the setting of the five cells, the terminal c is connected to the ground level via the jumper resistor 18 in the case of the setting of the two cells. Further, while the terminal d is connected to the battery having the second-lowest voltage among the five cells (negative voltage side of the battery block 103) in the case of the setting of the five cells, the terminal d is connected to the ground level via the jumper resistor 19 in the case of the setting of the two cells. Further, while the terminal e is connected to the battery having the third-lowest voltage among the five cells (negative voltage side of the battery block 102) in the case of the setting of the five cells, the terminal e is connected to the ground level via the resistor 20 in the case of the setting of the two cells.

In the protection board for protecting the battery of two cells shown in FIG. 4, the protection IC 2 for the lithium ion battery of five cells is mounted on the board. The terminal a of the protection IC 2 is connected to the ground level via the jumper resistor 16, the terminal b is connected to the ground level via the jumper resistor 17, the terminal c is connected to the ground level via the jumper resistor 18, the terminal d is connected to the ground level via the jumper resistor 19 and the terminal e is connected to the ground level via the resistor 20.

### List of Terminal Connections of Protection ICs Coping with Five to Two Cells

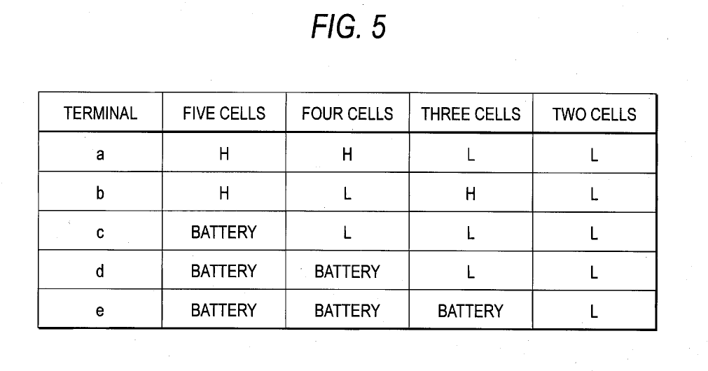

An arrangement of the terminal connections of the protection ICs coping with five to two cells explained with reference to FIGS. 1 to 4 will be shown in FIG. 5. That is, FIG. 5 shows a list of the terminal connections of the protection ICs coping with five to two cells in the battery packs according to the exemplary embodiment.

In FIG. 5, “H” represents that the corresponding terminal of the protection IC is connected to the battery voltage (the positive voltage side of the battery block 100) via the jumper resistor, whilst “L” represents that the corresponding terminal of the protection IC is coupled to the ground level via the jumper resistor. “Battery” represents that the corresponding terminal of the protection IC is connected to the negative voltage side of the corresponding battery block without being connected via the jumper resistor.

As explained above, in each of the cases where the batteries of five cells, four cells, three cells and two cells are to be protected, the protection IC 2 for the lithium ion battery of five cells is mounted, and the terminals a, b, c, d, e of the protection IC 2 are connected to the battery voltage or the grounding level via the jumper resistors 14 to 20 in correspondence with the number of the cells. In this manner, the protection board can be used commonly for the batteries in a range from five cells to two cells having different voltages. For example, in the case where the voltage per one cell is 4.2 volt, the voltages of the battery packs of five cells, four cells, three cells and two cells are set to 21 volt, 16.8 volt, 12.6 volt and 8.4 volt, respectively. Further, although the explanation is made as to the battery packs in a range from five cells to two cells with reference to FIGS. 1 to 4, the embodiment can also be applied to the battery pack of a single cell. In this case, for example, the terminal a is connected to the positive electrode side of the battery block 100 via the jumper resistor 14, and the remaining terminals b to e are respectively connected to the ground level via the jumper resistors.

As explained above, according to the exemplary embodiment, a circuit pattern 21 associated with different numbers of cells is provided on the board in order to commonly use the protection board irrespective of the number of cells arranged in the battery pack. That is, the exemplary embodiment is configured in a manner that the single protection board can cope with the battery packs in a range of one cell to five cells by changing the connection pattern of the circuit pattern 21 in accordance with the number of cells. The specific connection patterns are described above. Thus, the protection board coping with the different numbers of cells can be configured by merely providing the circuit pattern 21 so as to be able to cope with the battery cell set in a range of one cell to five cells in advance on the board and changing the connection of the circuit pattern 21 in accordance with the cell number, whereby the productivity can be improved.

Hereinafter, the explanation will be made as to a power tool mounting the battery pack using the protection board as shown in FIGS. 1 to 4. In the following, although the explanation is made as to examples of using five cells explained with reference to FIG. 1 and four cells explained with reference to FIG. 2, it will be clear that the invention can also be applied to examples of using three cells explained with reference to FIG. 3 and two cells explained with reference to FIG. 4.

### Power Tool Driven by Insertion Type Battery Pack

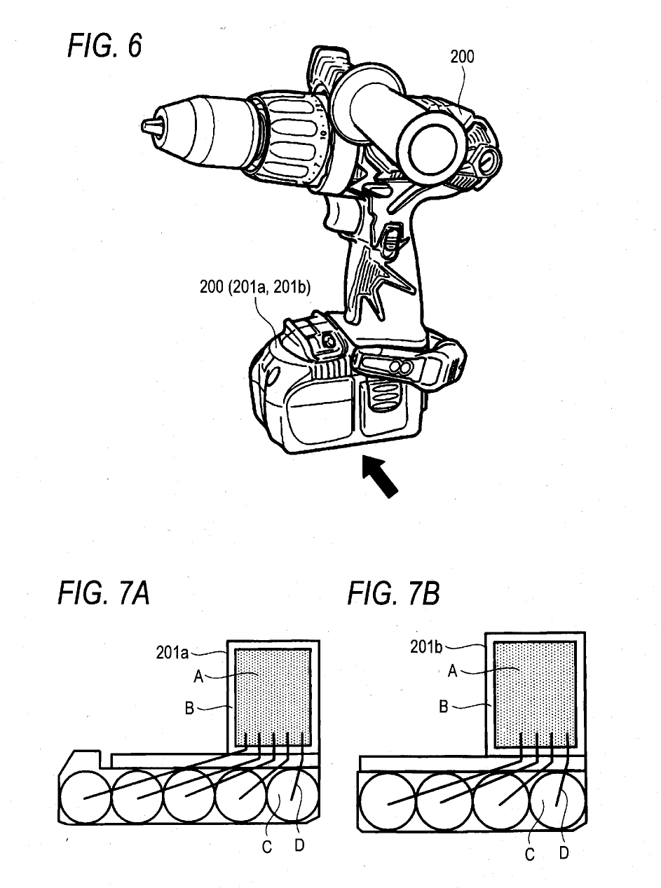

Next, the explanation will be made by using FIGS. 6, 7A and 7B as to a method of attaching an insertion type battery pack using the protection board shown in FIGS. 1 and 2 to a power tool. FIG. 6 is a diagram showing an example of the exterior view of the power tool driven by the insertion type battery pack. FIGS. 7A and 7B are diagrams showing examples (FIGS. 7A and 7B respectively show the battery packs of five cells and four cells) of the configurations of the insertion type battery pack for driving the power tool shown in FIG. 6. FIGS. 7A, B are schematic diagrams each showing the interior of the battery pack shown in FIG. 6 seen from the direction of an arrow.

The general power tool 200 has the exterior view as shown in FIG. 6. The battery pack 201 (201a, 201b) is attached in an insertion manner to the grip portion of the power tool 200. The battery pack 201 is configured as the battery pack 201a as shown in FIG. 7A in the case of five cells, whilst configured as the battery pack 201b as shown in FIG. 7B in the case of four cells.

The battery packs 201a, 201b are provided with insertion portions B which are inserted into the grip portion of the power tool 200 as shown in

FIGS. 7A and B, respectively. A protection board A on which circuit components including the protection IC 2 are mounted is disposed within the space of the insertion portion B. The shape of the insertion portion B and the shape of the space within the insertion portion are same between the battery pack of five cells shown in FIG. 7A and the battery pack of four cells shown in FIG. 7B, whereby it is possible to use the common protection board A therebetween. The protection board A is connected to terminals respectively corresponding to the discharging terminal 7, the charging terminal 8, the discharge stop signal transmission terminal 9, the charge stop signal transmission terminal 10, the temperature detection terminal 11, the battery kind detection terminal 12 and the negative terminal 13 shown in FIGS. 1 and 2. These respective terminals (not shown) are provided on the upper portion of the insertion portion B. The power tool 200 is provided with terminals which correspond to the discharging terminal 7, the discharge stop signal transmission terminal 9 and the negative terminal 13 and are connected to these terminals of the battery pack 201, respectively.

Battery cells C corresponding to the battery blocks 100 to 104, 100 to 103 of the lithium ion battery shown in FIGS. 1 and 2 are disposed at the outside of the insertion portion B. The battery pack 201a in the case of five cells is configured in a manner that the five battery cells C are disposed as shown in FIG. 7A, and wires D acting as detection lines and extending from the protection board A disposed within the space of the insertion portion B are respectively connected to the battery cells C to thereby monitor the cell voltages. Similarly, the battery pack 201b in the case of four cells is configured in a manner that the four battery cells C are disposed as shown in FIG. 7B, and wires D acting as detection lines and extending from the protection board A disposed within the space of the insertion portion B are respectively connected to the battery cells C to thereby monitor the cell voltages.

According to such the configuration, the protection board A can be used commonly between the battery packs of five cells and four cells in the battery pack 201 (201a, 201b) which is attached to the power tool 200 in the insertion manner. Of course, the protection board A can also be used commonly between the battery packs of three cells and two cells.

### Power Tool Driven by Slide Type Battery Pack

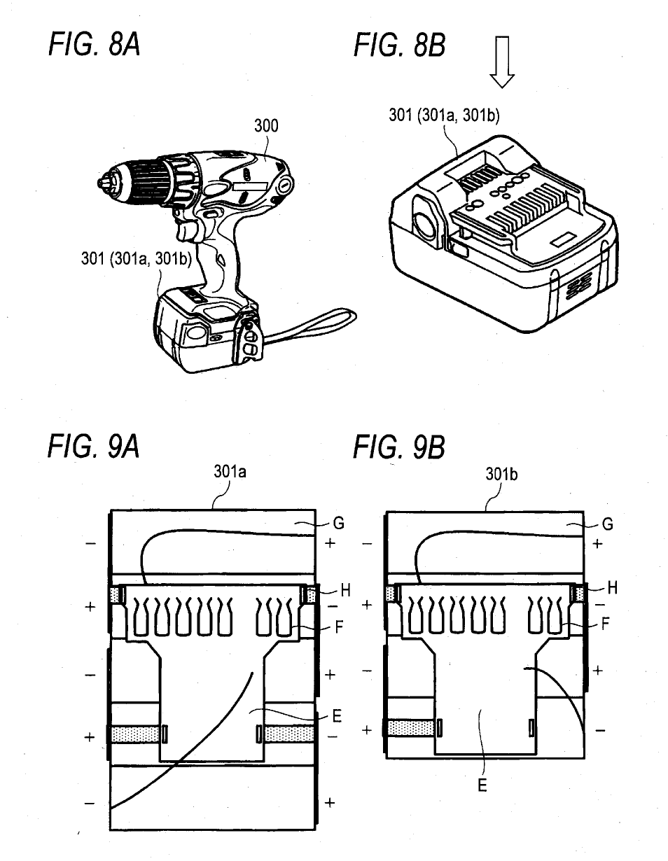

Next, the explanation will be made by using FIGS. 8A to 9B as to a method of attaching a slide type battery pack using the protection board shown in FIGS. 1 and 2 to a power tool. FIG. 8A is a diagram showing an example of the exterior view of the power tool driven by the slide type battery pack and FIG. 8B is a diagram showing an example of the exterior view of the battery pack. FIGS. 9A and 9B are diagrams showing examples (FIGS. 9A and 9B respectively show the battery packs of five cells and four cells) of the configurations of the slide type battery pack for driving the power tool shown in FIGS. 8A and 9B. FIGS. 9A, 9B are schematic diagrams each showing the interior of the battery pack shown in FIG. 8B seen from the direction of an arrow.

A power tool 300 having the different type of shape from the power tool 200 has the exterior view as shown in FIG. 8A. The battery pack 301 (301a, 301b) having the exterior view shown in FIG. 8B is attached in a sliding manner to the grip portion of the power tool 300. The battery pack 301 is configured as the battery pack 301a as shown in FIG. 9A in the case of five cells, whilst configured as the battery pack 301b as shown in FIG. 9B in the case of four cells.

A protection board E on which circuit components including the protection IC 2 are mounted is disposed within the space of each of the battery packs 301a, 301b as shown in FIGS. 9A and B, respectively. The shape of the spaces is same between the battery pack of five cells shown in FIG. 9A and the battery pack of four cells shown in FIG. 9B, whereby it is possible to use the common protection board E therebetween. The protection board E is provided with terminals F respectively corresponding to the discharging terminal 7, the charging terminal 8, the discharge stop signal transmission terminal 9, the charge stop signal transmission terminal 10, the temperature detection terminal 11, the battery kind detection terminal 12 and the negative terminal 13 shown in FIGS. 1 and 2. The power tool 300 is provided with terminals which correspond to the discharging terminal 7, the discharge stop signal transmission terminal 9 and the negative terminal 13 and are connected to these terminals of the battery pack 301, respectively.

Battery cells G corresponding to the battery blocks 100 to 104, 100 to 103 of the lithium ion battery shown in FIGS. 1 and 2 are disposed at the inner space of the battery packs 301a, 301b. The battery pack 301a in the case of five cells is configured in a manner that the five battery cells G are disposed as shown in FIG. 9A, and detection terminals H connected to the protection board E disposed within the inner space are respectively provided at the battery cells G to thereby monitor the cell voltages. Similarly, the battery pack 301b in the case of four cells is configured in a manner that the four battery cells G are disposed as shown in FIG. 9B, and detection terminals H connected to the protection board E disposed within the inner space are respectively provided at the battery cells G to thereby monitor the cell voltages.

According to such the configuration, the protection board E can be used commonly between the battery packs of five cells and four cells in the battery pack 301 (301a, 301b) which is attached to the power tool 300 in the sliding manner. Of course, the protection board E can also be used commonly between the battery packs of three cells, two cells and a single cell.

### Effects of Exemplary Embodiment

In the battery packs for protecting the lithium ion batteries of different voltages such as five cells, four cells, three cells and two cells, conventionally the protection boards are separately prepared according to the numbers of cells. However, according to the battery pack according to the exemplary embodiment and the power tool using it, the protection boards are made common irrespective of the numbers of cells, whereby the developing cost can be reduced.

Although the exemplary embodiment has been explained specifically based on the exemplary embodiment, the invention is not limited to the aforesaid exemplary embodiment and, of course, may be changed in various manners within a range not departing from the gist of the invention. For example, although the aforesaid exemplary embodiment is explained as to the lithium ion battery, a nickel-cadmium battery or a nickel hydride battery may be employed instead thereof.

The battery pack according to the invention can be used for a battery pack such as a lithium ion battery serving as the power source of a cordless power tool and the power tool using it.

1. A battery pack, comprising:
a battery set including at least one battery cell;
a protection IC configured to protect plural kinds of the battery sets, which produce different voltages, from overcharging and overdischarging, the protection IC including terminals for setting the different voltages of the battery sets; and
a board configured to mount, on a surface of the board, circuit components including the protection IC and a connection unit which is connected to the terminals based on the produced voltage of the battery set to be connected to the protection IC.

2. The battery pack according to claim 1, wherein
the connection unit includes jumper resistors which connect between the terminals of the protection IC and one of the batteries or a ground level on the board.

3. The battery pack according to claim 2, further comprising:
an insertion portion configured to attach the battery pack to a power tool,
wherein the insertion portion has a space where the board is disposed and where the battery cells are not disposed, and
wherein a shape of the insertion portion and a shape of the space are same in each of the battery sets which produce different voltages.

4. The battery pack according to claim 2, wherein
the protection IC has a function of monitoring voltages of the respective cells of the battery set, and
detection lines for monitoring the voltages of the cells are respectively connected between the cells and the board.

5. The battery pack according to claim 2, wherein
the protection IC has a function of monitoring voltages of the respective cells of the battery set,
detection terminals for monitoring the voltages of the cells are respectively set to the cells, and
the detection terminals are connected within the board.

6. The battery pack according to claim 1, wherein the connection unit is connected to the terminals in one of a plurality of circuit configurations based on the produced voltage of the battery set to be connected to the protection IC.

7. The battery pack according to claim 1, wherein the battery cell is a lithium ion battery.

8. A battery pack, comprising:
a battery set including at least one battery cell;
a protection IC configured to protect the battery cell from overcharging and overdischarging; and
a board which mounts circuit components including the protection IC thereon,
wherein a plurality of circuit patterns to be connected to the protection IC are formed on the board, and
wherein the protection IC is connected to at least one of the plurality of circuit patterns according to a number of the battery cells of the battery set to be protected.

9. A power tool using the battery pack according to claim 8.

10. A power tool using the battery pack according to claim 1.
